(19) United States
(12) Patent Application Publication
(10) Pub. No.: US 2008/0170733 A1
(43) Pub. Date: Jul. 17, 2008

(54) Charging device for a hearing aid, hearing aid and hearing aid remote control

(76) Inventor: Jurgen Reithinger, Neunkirchen am Brand (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/008,007

(22) Filed: Jan. 8, 2008

(30) Foreign Application Priority Data
Jan. 10, 2007 (DE) 102007001537.4

(51) Int. Cl. H04R 25/00; H02J 7/00

(52) U.S. Cl. 381/315; 320/107

(57) ABSTRACT

An induction charging method is provided, with a charging device being equipped with a charging capacitor comprising two opposing electrodes or plates. The device to be charged, a hearing aid or a hearing aid remote control, is introduced between the two electrodes into the electrical field of the capacitor. For energy coupling, the device to be charged is itself equipped with a capacitor which forms induction charges in dependence on the electrical field. The capacitor in the hearing aid or the hearing aid remote control can be manufactured very compactly from foils or coatings so that a significant amount of installation space can be saved for the inductive charging compared to magnetic receiving coils.

### CROSS REFERENCE TO RELATED APPLICATIONS

This application claims priority of German application No. 102007001537.4 DE filed Jan. 10, 2007 which is incorporated by reference herein in its entirety.

### FIELD OF INVENTION

The present invention relates to a charging device for a hearing aid and/or a hearing aid remote control with a power supply unit to provide a charging voltage or a charging current. In addition, the present invention relates to a hearing aid or a hearing aid remote control, which can be charged with the above charging device or the above charging method.

### BACKGROUND OF INVENTION

Frequently, there is a requirement to charge batteries of a hearing aid or a hearing aid remote control not by means of a wire lead but without a direct cable connection. Therefore, the charging energy has to be transmitted in a wireless way from a charging station to the hearing aid or the hearing aid remote control. To do this, an energy reception circuit with an associated receiver component (e.g. antenna) has to be integrated in the device to be charged. On the one hand, this requires space, but, on the other hand, the wireless transmission of the energy to the device to be charged does not require a charge connecting contact.

Up to now, typically, the inductive method has been used for the wireless charging of batteries. The transmitter works with a transmission coil and the recipient of the energy also uses a coil to receive the energy. Coils of this kind are comparatively large and the energy is transmitted via magnetic fields which are difficult to shield from the outside. However, the inductive transmission can generate relatively high currents in the energy reception coil.

Hearing aids are portable hearing devices provided to people with impaired hearing. In order to accommodate the numerous individual requirements, different designs of hearing aids are provided, such as, for example, behind-the-ear-hearing aids (BTEs), in-the-ear-hearing aids (ITEs), for example also concha-hearing aids or completely-in-the-canal hearing aids (CICs). The hearing aids described by way of example are worn on the outer ear or in the auditory canal. In addition, also available on the market are bone conduction hearing aids, implantable or vibrotactile hearing aids. In such cases, the damaged hearing is stimulated either mechanically or electrically.

In principle, hearing aids have the following essential components: an input transducer, an amplifier and an output transducer. The input transducer is generally a sound pickup, for example a microphone, and/or an electromagnetic receiver, for example an induction coil. The output transducer is generally implemented as an electroacoustic transducer, for example a miniature loudspeaker, or as an electromechanical transducer, for example a bone conduction hearing aid. The amplifier is usually integrated in a signal processing unit. This basic structure is shown in FIG. 1 using the example of a behind-the-ear hearing aid. One or more microphones 2 to pick up the sound from the environment are integrated in a hearing aid housing 1 for wearing behind the ear. A signal processing unit 3, which is also integrated in the hearing aid housing 1 processes and amplifies the microphone signals. The output signal from the signal processing unit 3 is transmitted to a loud speaker or receiver 4, which issues an acoustic signal. The sound may optionally be transmitted via an acoustic tube, which is fixed in the auditory canal with an otoplastic, to the eardrum of the person wearing the device. The power supply for the hearing aid and in particular for the signal processing unit 3 is provided by a battery 5 which is also integrated in the hearing aid housing 1.

The patent GB 2 198 601 A1 describes a rechargeable reservoir comprising battery cells or capacitors. The reservoir comprises electrodes which are capacitively coupled to electrodes of a high-frequency alternating current charging source. Diodes coupled to the electrodes cause the reservoir to be charged by the positive and negative half cycles of the charging current.

### SUMMARY OF INVENTION

The object of the present invention is to provide chargeable hearing aids and hearing aid remote controls in a smaller design and hence to provide a corresponding charging device or a corresponding charging method. In addition, it is intended to disclose hearing aids or hearing aid remote controls suitable for this purpose.

The present invention is based on the idea of using an induction charging method for a hearing aid or a hearing aid remote control, that is a capacitive charging method, even if this can only achieve a low energy transmission rate, because the advantages of a method of this kind are particularly crucial for hearing aids and hearing aid remote controls. Namely: wireless charging does not require any voluminous coils; instead it is possible to use capacitors requiring comparatively little installation space for the charging.

Correspondingly, it is envisaged to provide a charging device for a hearing aid and/or a hearing aid remote control with a power supply unit for supplying a charging voltage and a capacitor with two opposing electrodes, with it being possible to introduce a hearing aid or a hearing aid remote control between the two electrodes into the electrical field of the capacitor. The capacitor of the charging device comprises as electrodes at least four plates which face each other in pairs.

Correspondingly, also provided is a hearing aid or hearing aid remote control with a housing and an energy store, with a capacitor or a part of a capacitor being arranged on the housing, which serves to charge the energy store through an external electrical field. The housing is provided at least partially with a conductive foil or coating. A foil of this kind can be easily applied to the housing or to the internal surface of the housing. The coating can be applied without much effort in a space-saving way for example to the internal surface of the housing. Alternatively, with the hearing aid according to the invention or the corresponding hearing aid remote control, an electrode of the energy store forms a capacitor electrode. Optionally, at least one part of the housing forms the other electrode of the charging capacitor. This also enables a significant amount of space to be saved.

In a special embodiment of the charging device, the capacitor can also comprise six plates arranged in a cube shape. This means the orientation with which the device to be charged is introduced into the charging device is of little significance.

Preferably, the capacitor is part of an LC oscillating circuit. This enables the achievement of a comparatively high energy transmission rate. It can be particularly favorable for the housing to be provided wholly or partially with at least two conductive foils, between which an insulator is glued. This enables the provision of a complete capacitor in a manner which saves a great deal of space.

### BRIEF DESCRIPTION OF THE DRAWINGS

The present invention will now be explained in more detail with reference to the drawings, which show:

FIG. 1 the basic design of a hearing aid and

FIG. 2 a circuit diagram of an induction charging system as claimed in the present invention.

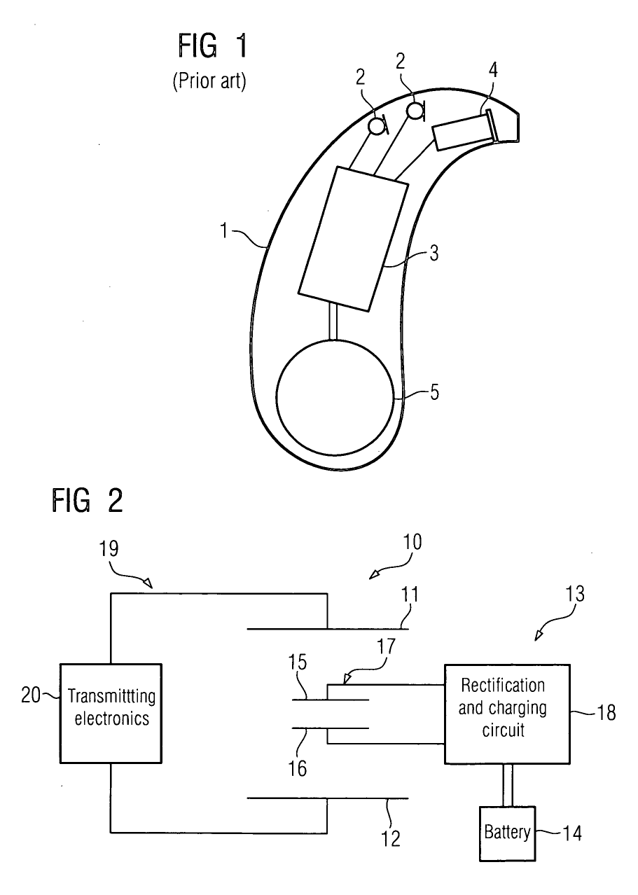

### DETAILED DESCRIPTION OF INVENTION

The examples described in more detail in the following represent preferred embodiments of the present invention.

Instead of using a magnetic field, the transmission of energy from a charging device to a hearing aid or a hearing aid remote control can also take place via an electrical field. In this case, instead of a transmitting coil, a transmitting capacitor 10 is required in the charging device, as shown in FIG. 2. This capacitor 10 comprises two opposing plates 11 and 12, between which the device to be charged 13 with its integrated battery 14 is positioned. This device 13, namely a hearing aid or a hearing aid remote control, also comprises two plates 15, 16 which form a capacitor 17. The capacitor 17 is connected via a rectification and charging circuit 18 to the battery 14 in order to charge said battery. In addition, the capacitor 10 of the charging device 19 is connected to transmitting electronics 20 in order to provide the corresponding charging energy by means of an alternating current or an alternating voltage.

During the charging, an electrical field is established between the plates 11, 12 of the charging device 19. In this electrical field, the plates 15, 16 of the device to be charged now establish induction charges. If the electrical field changes the polarity, the induction charge on the plates 15, 16, also changes provided that a flow of current between the plates is possible. This causes an alternating current to be generated between the plates 15, 16 which can be rectified via the circuit 18 and used for charging the batteries 14.

The voltage at the plates 15, 16 is determined by the strength of the electrical field and the size of the plates. The current that may be taken from the plates 15, 16 results from the voltage and the frequency of the electrical field.

The capacitor plates 15, 16 in the device to be charged 13 can be embodied as metal plates, as conductive flexible foils or as conductive coatings on non-conductive surfaces (e.g. the housing). Metallic surfaces which are also present can be used at least for one of the two plates. For example, the metal surface of a button cell battery can be used as a plate. However, here there is the drawback that only one half-cycle rectification is possible instead of a full-cycle rectification.

With a behind-the-ear hearing aid, an already present metal coating on the internal surface of the housing can be used as a capacitor. In such a case, it is only necessary to ensure that the coatings on the two housing halves are not in direct contact. Consequently, a corresponding small gap should be provided between the two housing halves. The contacting of the coating can, for example, take place via simple spring contacts.

The charging electronics or charging circuit 18 can either be integrated in the device to be charged 13 or only the charging voltage and the charging current are measured in the device in order to control the charging process. The measured values can be transmitted for example via a radio interface to the charging device 19. There, the field generated can be controlled appropriately.

If the charging device 19 is embodied as a cube with respect to the design of the capacitor 10, three pairs of plates can form this cube. If the three pairs of plates are now each controlled alternately, the receiving plates 15, 16 of the device to be charged 13 can lie in any orientation inside the cube. Then, the received energy only fluctuates between 50% in the most unfavorable case and 100% in the most favorable case.

If an LC oscillating circuit is used in the charging device 19 for the interconnection of the transmitting capacitor or capacitors 10, the energy can be transmitted very efficiently, since it is then only necessary to supply a small amount of active power corresponding to the losing and the charging energy.

In an advantageous way, when using electrical fields for the energy transmission, the shielding of these fields from the outside can be achieved in a relatively simple way. A metal box is usually completely sufficient for this. By contrast, in the case of inductive transmission, shielding a magnetic field from the exterior is comparatively difficult.

A further advantage of the induction charging system according to the invention consists in the low installation space required. It is precisely with hearing aids, for which the space required for the components is of importance, that a coil for the energy reception can cause significant space problems. Therefore, it is not possible to use an energy reception coil in every hearing aid. Capacitor plates on the other hand can be of a very thin and hence very space-saving design. Under certain circumstances, thin metal coatings on hearing aids or housing components are sufficient. Electrically conductive foils can also be used and are of particular advantage in the case of irregular surfaces. Especially in the case of in-the-ear hearing aids, foils of this kind for the charging capacitor can be inserted very flexibly in the individual housing shells. Similarly, it is also possible to use two foils with an insulator glued between them as a deformable capacitor. In such a case, there is no risk of a short circuit between the two plates.

In particular, small devices such as hearing aids require batteries that are not all that large. This means the unquestionably higher energy transmission via magnetic fields is not required. Namely, small plates and sufficiently high field frequencies for the electrical field are able to transmit sufficiently high quantities of energy for small batteries. If the charging device has suitable transmitting electronics, a commercially available primary battery can suffice for the charging device in order to charge a small button cell battery in a hearing aid by wireless means.

1.-5. (canceled)

6. A charging device for charging a charged device, comprising:
a power supply unit for the provision of a charging voltage; and
a capacitor comprising a plurality of electrodes in order to introduce further device between the electrodes into an electrical field of the capacitor, each electrode paired such that each pair comprises two opposing plates,
wherein the further device is a hearing aid or a hearing aid remote control.

7. The charging device as claimed in claim 6, wherein the capacitor comprises six plates arranged in a cube shape.

8. The charging device as claimed in claim 7, wherein the cube shape is such that the orientation with which the further device is introduced into the charging device has little significance.

9. The charging device as claimed in claim 6, wherein the charging device receives, via a radio interface, a charging voltage and charging current measured by the further device, the received measurements control the field generated by the capacitor.

10. The charging device as claimed in claim 6, wherein the capacitor is part of an LC oscillating circuit.

11. A hearing aid or hearing aid remote control, comprising:
a housing;
an energy store; and
at least a part of a capacitor to load the energy store through an external electrical field, the capacitor arranged in or on the housing,
wherein the housing is provided at least partially with a conductive foil or coating.

12. The hearing aid or hearing aid remote control as claimed in claim 11, wherein the housing comprises two conductive foils between which an insulator is glued in place.

13. A hearing aid or hearing aid remote control, comprising:
a housing;
an energy store;
at least a part of a capacitor to load the energy store through an external electrical field, the capacitor arranged in or on the housing; and
an electrode of the energy store with a further metal surface form the capacitor.

14. The hearing aid or hearing aid remote control as claimed in claim 13, wherein the housing comprises two conductive foils between which an insulator is glued in place.
